(19) United States
(12) Patent Application Publication
(10) Pub. No.: US 2015/0095156 A1
(43) Pub. Date: Apr. 2, 2015

(54) SERVICING SUBSCRIBER VEHICLES

(71) Applicant: GENERAL MOTORS LLC, Detroit, MI (US)

(72) Inventors: STEVEN S. SAUERBREY, FARMINGTON HILLS, MI (US); WAHAJ AHMED, DEARBORN, MI (US); HUONG T. CHIM, TROY, MI (US)

(73) Assignee: GENERAL MOTORS LLC, Detroit, MI (US)

(21) Appl. No.: 14/041,069

(22) Filed: Sep. 30, 2013

(51) Int. Cl. G06Q 30/02; H04W 4/00; H04W 4/02

(52) U.S. Cl. CPC G06Q 30/0281; G06Q 30/0261; H04W 4/021; H04W 4/008
USPC 705/14.58; 705/346

(57) ABSTRACT

At a server, a notification that a subscriber vehicle has an appointment with a dealership is received. A geo-fence is set up around the dealership. At the server, it is recognized that the subscriber vehicle has entered the geo-fence. Subscriber vehicle identifying data is received at the server, and in-vehicle infotainment capabilities of the subscriber vehicle are identified at the server by interrogation of a database in connection with the server. From the server, a message is transmitted to the subscriber vehicle that is tailored to the in-vehicle infotainment capabilities.

### TECHNICAL FIELD

The present disclosure relates generally to method(s) and system(s) for servicing subscriber vehicles.

### BACKGROUND

Various commercial establishments are designed to provide services to consumer vehicles, and sometimes these services are provided in exchange for payment. Short range wireless communication technologies have been utilized to perform some commercial transactions with customer vehicles. One example of this technology includes a smart card that may be used to render a payment by waving the card near a card reader. Another example includes a key fob device programmed with credit or debit information, and this programmed key fob may be waved near a reader to render a payment.

### SUMMARY

Method(s) and system(s) for servicing a subscriber vehicle are disclosed herein. In an example of the method, a notification that a subscriber vehicle has an appointment with a dealership is received at a server. A geo-fence is set up around the dealership. At the server, it is recognized that the subscriber vehicle has entered the geo-fence. Subscriber vehicle identifying data is received at the server, and in-vehicle infotainment capabilities of the subscriber vehicle are identified at the server by interrogation of a database in connection with the server. From the server, a message is transmitted to the subscriber vehicle that is tailored to the in-vehicle infotainment capabilities.

### BRIEF DESCRIPTION OF THE DRAWINGS

Features and advantages of examples of the present disclosure will become apparent by reference to the following detailed description and drawings, in which like reference numerals correspond to similar, though perhaps not identical, components. For the sake of brevity, reference numerals or features having a previously described function may or may not be described in connection with other drawings in which they appear.

FIG. 1 is a schematic diagram depicting an example of a system for servicing a subscriber vehicle; and

FIG. 2 is a schematic flow diagram depicting an example of a method for servicing a subscriber vehicle.

### DETAILED DESCRIPTION

In examples of the method and system disclosed herein, a subscriber vehicle is identified at a dealership, and a welcome and/or other message is transmitted to the subscriber vehicle. The message is specifically tailored to the in-vehicle infotainment capabilities of subscriber vehicle. The specifically tailored message may range from a text message and/or an audio message to a message that includes a video for display within the vehicle. In some instances, the message is also specifically tailored to the vehicle owner or other occupant(s). It is believed that the customer service experience may be enhanced with the targeted/tailored message.

It is to be understood that, as used herein, the term “user” includes a vehicle owner, a vehicle driver, and/or a vehicle passenger. In instances where the user is the vehicle owner, the term “user” may be used interchangeably with the terms subscriber and/or service subscriber.

The term “communication” is to be construed to include all forms of communication, including direct and indirect communication. Indirect communication may include communication between two components with additional component(s) located therebetween.

Further, the terms “connect/connected/connection” and/or the like are broadly defined herein to encompass a variety of divergent connected arrangements and assembly techniques. These arrangements and techniques include, but are not limited to (1) the direct communication between one component and another component with no intervening components therebetween; and (2) the communication of one component and another component with one or more components therebetween, provided that the one component being “connected to” the other component is somehow in operative communication with the other component (notwithstanding the presence of one or more additional components therebetween).

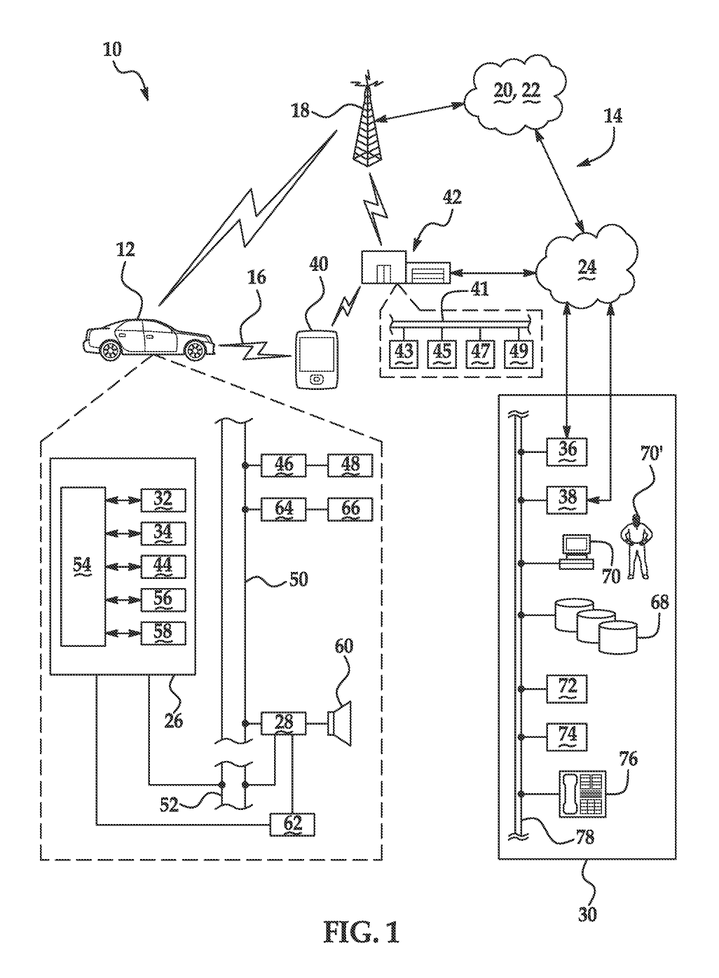

FIG. 1 depicts an example of a system 10 for servicing a subscriber vehicle 12. The subscriber vehicle 12 is a vehicle, such as a car, motorcycle, truck, or recreational vehicle (RV), and is equipped with suitable hardware and computer-readable instructions/code that enable it to communicate (e.g., transmit and/or receive voice and data communications) over a carrier/communication system 14 and/or using a short-range wireless communication link 16.

In an example, the carrier/communication system 14 is a two-way radio frequency communication system. The carrier/communication system may include one or more cell towers 18. It is to be understood that the carrier/communication system 16 may also include one or more base stations and/or mobile switching centers (MSCs) 20 (e.g., for a 2G/3G network), one or more evolved Node Bs (eNodeB) and evolved packet cores (EPC) 22 (for a 4G (LTE) network), and/or one or more land networks 24. The carrier/communication system 14 is part of a cellular radio environment, which may include a variety of wireless network providers (which include mobile network operator(s), not shown), utilizing the same or a variety of radio access technologies.

The wireless carrier/communication system 14 may be used to establish communication between an in-vehicle telematics unit 26 or an in-vehicle infotainment unit 28 and any outside communications device or system (e.g., a mobile/smart phone, a landline telephone, communication component(s) at a call center 30, etc.). In an example, the in-vehicle telematics unit 26 or the in-vehicle infotainment unit 28 includes a cellular chipset/component 32 (shown in the telematics unit 26) that may be an analog, digital, dual-mode, dual-band, multi-mode and/or multi-band cellular phone. The cellular chipset-component uses one or more prescribed frequencies in standard analog and/or digital bands in the current market for cellular systems. Any suitable protocol may be used, including digital transmission technologies, such as TDMA (time division multiple access), CDMA (code division multiple access), and FDMA (frequency-division multiple access). The architecture of the wireless carrier/communication system may be GSM (global system for mobile telecommunications), CDMA2000, UMTS (universal mobile telecommunications system), or LTE (long-term evolution).

Some vehicle communications (e.g., between the vehicle 12 and a server 38 or a switch 36 at a call center 30) utilize radio transmissions to establish a voice channel with the carrier/communication system 14 such that both voice and data transmissions may be sent and received over the voice channel. In some instances, vehicle communications are enabled via the cellular chipset/component 32 for voice communications and a wireless modem 34 for data transmission. In order to enable successful data transmission over the voice channel, wireless modem 34 applies some type of encoding or modulation to convert the digital data so that it can communicate through a vocoder or speech codec incorporated in the cellular chipset/component 32. It is to be understood that any suitable encoding or modulation technique that provides an acceptable data rate and bit error may be used with the examples disclosed herein.

The in-vehicle telematics unit 26 or the in-vehicle infotainment unit 28 may also be configured for short-range wireless communication technologies, such as BLUETOOTH®, dedicated short-range communications (DSRC), or Wi-Fi™. In these instances, the cellular chipset/component 32 may operate in conjunction with a short-range wireless communication unit 44 of the telematics unit 26 or infotainment unit 28. Short-range wireless communications may be suitable for communication between, for example, the unit 16 or 18 and an electronic device 40 (e.g., a tablet computer) at a dealership 42. In an example, the dealership 42 may include a wireless access point (WAP, also known as a hotspot for Wi-Fi™ connections), which allows wireless devices to connect to a wired network using BLUETOOTH®, Wi-Fi™ or other similar standards. The use of short-range wireless communication technologies will depend, at least in part, on the distance of the vehicle 12 from the WAP. For example, the WAP may have a preset wireless access range for Wi-Fi™ connections, or may have a standard range of about 20 meters (i.e., about 65 feet) indoors, and a larger range outdoors. When the WAP is configured for BLUETOOTH® connections, the WAP may have a preset wireless access range, or may have a standard range of about 10 meters (i.e., about 32 feet). As such, Wi-Fi™ may be more desirable when the distances are slightly longer than those distances for which BLUETOOTH® and dedicated short-range communications (DSRC) are used.

Overall, the in-vehicle telematics unit 26 is an on-board vehicle dedicated communications device that also includes hardware components that are capable of running computer-readable instructions/code, which are embodied on non-transitory, tangible computer-readable media. In any of the examples disclosed herein, the computer-readable media may include any one of many physical media such as, for example, electronic, magnetic, optical, electromagnetic, or semiconductor media. More specific examples of suitable computer-readable media include hard drives, a random access memory (RAM), a read-only memory (ROM), an erasable programmable read-only memory (EPROM), or a portable CD, DVD, or flash drive.

The in-vehicle telematics unit 26 may provide a variety of services, both individually and through its communication with the call center 30 (e.g., a facility that may be owned and operated by an in-vehicle telematics service provider). Several examples of these services include, but are not limited to: turn-by-turn directions and other navigation-related services provided in conjunction with Global Position System (GPS) based chipset/component; airbag deployment notification and other emergency or roadside assistance-related services provided in connection with various crash and/or collision sensor interface modules 46 and sensors 48 located throughout the vehicle 12; and infotainment-related services where music, Web pages, movies, television programs, videogames and/or other content is downloaded by the infotainment unit 28 operatively connected to the telematics unit 26 via a vehicle bus system 50 and an audio bus system 52. The listed services are by no means an exhaustive list of all the capabilities of the telematics unit 26, but are simply an illustration of some of the services that the in-vehicle telematics unit 26 is capable of offering.

The telematics unit 26 generally includes an electronic processing device 54 operatively coupled to one or more types of electronic memory 56 and an electronic vehicle geographic location system 58. In an example, the electronic processing device 54 is a micro-processor. In other examples, the electronic processing device 54 may be a micro controller, a controller, a host processor, and/or a vehicle communications processor. In another example, electronic processing device 54 may be an application specific integrated circuit (ASIC). Alternatively, electronic processing device 54 may be a processor working in conjunction with a central processing unit (CPU) performing the function of a general-purpose processor. In an example, the electronic processing device 54 is capable of running software programs having computer-readable code/instructions to generate a geo-fence.

The electronic memory 56 of the telematics unit 26 may be an encrypted memory that is configured to store computer-readable instructions/code to be executed by the processor 54, data associated with the various systems of the vehicle 12 (i.e., vehicle data), vehicle operations, vehicle user preferences and/or personal information, and the like. In an example, the electronic memory 56 also stores an identification code that allows the vehicle telematics unit 26 (or infotainment unit 18) to connect to the WAP at the dealership. In an example, the identification code is an access point identifier (also referred to as service set identifier (SSID)), which is a previously approved identifier that the vehicle 12 may use to establish short range wireless connections with the WAP at the dealership 42. In one example, the WAP is configured with Wi-Fi™ technology so that the telematics unit 54 can wirelessly connect with the WAP. The access point identifier provides the telematics unit 26 with access to the particular WAP. In another example, the identification code is a pre-shared wireless connection key that can be used to establish a short range wireless connection with the WAP. The wireless connection key may be a security code of the telematics unit 26 (or unit 28) that is generated during pairing (e.g., a BLUETOOTH® pairing) of the telematics unit 26 (or unit 28) and the WAP. The key may also be used by the unit 26 or 28 to establish its identity and authenticity for communications with the electronic device 40 that operates using the WAP. It is to be understood that the WAP also generates its own wireless connection key, and the unit 26 or 28 and the WAP are considered to be paired when they exchange their respective wireless connection keys.

The electronic vehicle geographic location system 58 is a location detection chipset/component that may include a GPS receiver, a radio triangulation system, a dead reckoning position system, and/or combinations thereof. In particular, a GPS receiver provides accurate time and latitude and longitude coordinates of the vehicle 12 responsive to a GPS broadcast signal received from a GPS satellite constellation (not shown). The location detection chipset/component may also include, for example, Glonass (i.e., global navigation satellite system), Sbas (i.e., satellite-based augmentation systems), or a D-GPS (differential global positioning system). The electronic vehicle geographic location system 58 may be used to recognize that the vehicle 12 has broken a geo-fence that is set up around the dealership 42. The electronic vehicle geographic location system 58 can transmit signal(s) to the server 38 at the call center 30 that are indicative of the position of the vehicle 12 and/or that inform the server 38 that the vehicle 12 has entered/broken the geo-fence.

While not shown, it is to be understood that the in-vehicle telematics unit 26 may also include a navigation unit containing the previously mentioned electronic vehicle geographic location system 58, a real-time clock (RTC), a short-range wireless antenna, and/or a dual mode antenna. Generally, dual mode antenna services the location detection chipset/component and the cellular chipset/component 32. It is to be understood that the in-vehicle telematics unit 26 may be implemented without one or more of the above listed components (e.g., the real-time clock). It is to be further understood that in-vehicle telematics unit 26 may also include additional components and functionality as desired for a particular end use.

The real-time clock (RTC) provides accurate date and time information to the in-vehicle telematics unit 26 hardware and software components that may require and/or request date and time information. In an example, the RTC may provide date and time information periodically, such as, for example, every ten milliseconds.

The telematics unit 26 and the infotainment unit 28 are also operatively connected to the vehicle bus system 50. The vehicle bus system 50 may utilize a variety of networking protocols, such as a controller area network (CAN), a media oriented system transfer (MOST), a local interconnection network (LIN), an Ethernet or TCP/IP, and other appropriate connections such as those that conform with known ISO, SAE, and IEEE standards and specifications, to name a few. The vehicle bus system 50 enables the vehicle 12 to send signals (i.e., real-time bus messages) from the unit 26 and/or 28 to various units of equipment and systems both outside the vehicle 12 and within the vehicle 12 to perform or initiate various functions, such as unlocking a door, executing personal comfort settings, and/or the like. The vehicle bus system 50 also enables the vehicle 12 to receive signals at the units 26, 28 from various units of equipment and systems both outside the vehicle 12 and within the vehicle 12.

It is to be understood that the infotainment unit 28 may include any of the communication (or other) components previously described and may also include its own electronic processing unit and memory. The infotainment unit 28 may include an audio component that receives analog information, rendering it as sound, via the audio bus system 52. Digital information may be received at the infotainment unit 28 via the vehicle bus system 50. The audio component may provide AM and FM radio, high-definition radio, satellite radio, CD, DVD, multimedia, and other like functionality, in conjunction with a controller/processor of the infotainment unit 28. The infotainment unit 28 may contain a speaker system, or may utilize vehicle speaker 60 via arbitration on vehicle bus system 50 and/or audio bus system 52.

The vehicle 12 may also include a display 62. The display 62 may be operatively directly connected to or in communication with the telematics unit 26, and/or may be operatively directly connected to or in communication with the infotainment unit 28. In an example, the display 62 may be used to display navigation instructions and other messages (e.g., tailored messages from the dealership 42) to the in-vehicle occupant(s). Examples of the display 62 include a VFD (Vacuum Fluorescent Display), an LED (Light Emitting Diode) display, a driver information center display, a radio display, an arbitrary text device, a heads-up display (HUD), an LCD (Liquid Crystal Diode) display, and/or the like. In an example, the display 62 is capable of playing high-definition or other videos.

As illustrated in FIG. 1, the vehicle 12 may also include other vehicle systems that are connected to the vehicle bus system 24. Examples of these other vehicle systems may include the crash and or collision sensors 48 and other vehicle sensors 66. The crash sensors 48 provide information to the telematics unit 26 via the crash and/or collision detection sensor interface 46 regarding the severity of a vehicle collision, such as the angle of impact and the amount of force sustained. The other vehicle sensors 66, connected to various sensor interface modules 64, are also operatively connected to the vehicle bus system 50. Examples of the other vehicle sensors 66 include, but are not limited to, key detecting sensors, gyroscopes, accelerometers, magnetometers, emission detection and/or control sensors, lane departure sensors (e.g., video sensors, laser sensors, infrared sensors, etc.), speed sensors, following distance sensors (e.g., radar sensors, video sensors, infrared sensors, ultrasonic sensors, etc.), braking activity sensors, environmental detection sensors, and/or the like. Examples of the sensor interface modules 66 include powertrain control module, climate control, body control, and/or the like. It is to be understood that in the examples disclosed herein, any data collected by the sensors 48 and/or 66 may be transmitted as vehicle data to the electronic device 40 at the dealership 42 (as will be discussed below) or to the call center 30 for storage in a database 68.

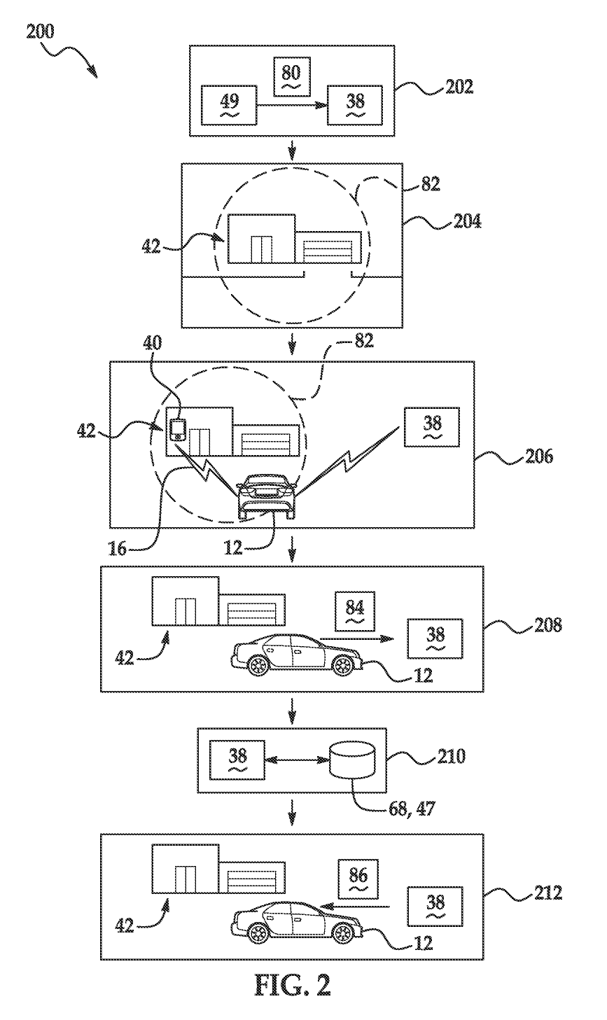

As shown in FIG. 1, the subscriber vehicle 12 may be in selective communication, simultaneously or at different times, with both the dealership 42 and the call center 30. It is to be understood that the dealership 42 and the call center 30 may also be in direct and selective communication with one another. It is to be understood that the system 10 components related to the dealership 42 and the call center 30 will be described in reference to both FIGS. 1 and 2. FIG. 2 illustrates an example of the method 200 for servicing a subscriber vehicle 12, which involves the vehicle 12, the dealership 42, and the call center 30 of the system 10.

The dealership 42 includes the previously described WAP (not shown) and the electronic device 40. In an example, the electronic device 40 is a wireless tablet computer or some other wireless communications device that is configured to access the dealership's computer network through the WAP. The electronic device 40 is to be used by the dealership employees to retrieve customer and/or vehicle information, to set up appointments, to create and maintain sales and/or service records, to accept customer payments, and/or to perform any other computer-related tasks associated with running the dealership 42.

As shown in FIG. 1, the dealership 42 may also include other computer equipment, such as processor(s) 43, server(s) 45, database(s) 47, communication module(s) 49, etc. that are operatively connected to a dealership bus 41 (similar to buses 50 and 78) for receiving and storing vehicle and customer data/information and appointments, and for transmitting at least appointment information to the call center server(s) 38.

In the examples disclosed herein, the call center 30 may be associated with a telematics service provider that provides vehicle related services and/or vehicle communication related services to the subscriber vehicle 12. According to the example shown in FIG. 1, the call center 30 generally includes one or more servers 38, switches 36, databases 68, live and/or automated advisors 70, 70′, processing equipment (or processor) 72, communications modules 74, as well as a variety of other telecommunication and computer equipment 76 that is known to those skilled in the art. These various call center components are coupled to one another via a network connection or bus 78, such as one similar to the vehicle bus 50 previously described in connection with the vehicle 12.

The server 38 is selectively connected to the vehicle 12 and to one or more of the computing systems (e.g., server 43, communication module 49, etc.) at the dealership 42. The server 38 is a system of computer hardware and software that assists in providing the targeted/tailored messaging to the subscriber vehicle 12 when arriving at the dealership 42. The hardware of the server 38 runs software (i.e., computer readable code/instructions) that enables the server 38 to perform many of the steps of the method 200 disclosed herein.

In an example, the hardware of the server 38 runs software that enables the server 38 to receive a notification 80 (see FIG. 2, reference numeral 202) from the communications module 49 at dealership 42 that the subscriber vehicle 12 has an appointment scheduled at the dealership 42.

Prior to receiving the notification 80 from dealership communication module 49, it is to be understood that the user of the subscriber vehicle 12 may set up an appointment with the dealership 42 via the phone (through an automated system or a live person), a dealer webpage, or a dealer application resident on the user's mobile communications device. The appointment is then saved in a memory (not shown) associated with the dealer's computer equipment. The dealership's processor 43 or server 45 is programmed to recognize which vehicles are subscriber vehicles (i.e., a vehicle that has signed up for telematics related services, including the messaging service disclosed herein, through the telematics service provider). In an example when a user signs up for telematics services upon purchasing the vehicle 12 from the dealership 42, the vehicle records maintained and stored at the dealership 42 may be updated to reflect the “subscriber vehicle” status. In another example when a user signs up for telematics services through the call center 30 or a website of the telematics service provider, the call center advisor (e.g., 70 or 70′) or the communications module 74 may transmit a message to the dealership 42 (e.g., to an employee or to the communication module 49) informing the dealership 42 that the vehicle 12 (which may be identified by its vehicle identification number, VIN) has become a subscriber vehicle. The dealership 42 (manually by an employee or automatically by the processor 43) can update the vehicle records maintained and stored at the dealership 42.

Once the dealership records include the subscriber status of the vehicle 12, the processor 43 or server 45 is configured to recognize this status when an appointment is made for the vehicle 12. Once an appointment is made and recognized, the communications module 49 is programmed to automatically transmit the appointment information to the server 38 at the call center 30, as shown at reference numeral 202 in FIG. 2.

As shown at reference numeral 204 in FIG. 2, in an example of the method 200, in response to receiving the notification 80, the server 38 sets up a geo-fence 82 around the dealership 42. The geo-fence 82 is a virtual perimeter around at least the entrance to the dealership 42. The geo-fence 82 may include a boundary defined by GPS coordinates. The geo-fence 82 may also be defined using a radius and the dealership 42 as a center point, where the center point is a latitude and longitude coordinate. In another example, the processor 54 associated with the telematics unit 26 is capable of setting up the geo-fence 82 in response to a command signal from the server 38.

The server 38 also includes software to recognize when the vehicle 12 has broken, crossed, or entered the geo-fence 82. In an example, the telematics unit 26 may be made aware of the geo-fence 82 either by the server 38 or as a result of setting up the geo-fence 82. The telematics unit 26 then continuously monitors its then-current location, calculates a radius from the dealership center point, and compares the distance of the geo-fence 82 to the distance of the vehicle 12 from the dealership center point via the following formula:

Distance=ar cos(sin(latitude_coordinate_of_dealership_center_point)*sin(latitude_coordinate_of_vehicle)+cos(latitude_coordinate_of_dealership_center_point)*cos(latitude_coordinate_of_vehicle)*cos(longitude_coordinate_of_dealership_center_point−longitude_coordinate_of_vehicle)).

The Distance value yields the radius of the vehicle 12 and the center of the dealership in radians. In this example, the radian value is converted to nautical miles using the formula nautical miles=distance*3437.7387. In this example, the nautical miles may be converted to statute (land) miles by multiplying the nautical miles by 1.150799, and the statute (land) miles may be converted to feet by multiplying the statute (land) miles value by 5280. If the radius of the vehicle 12 and the center of the dealership 42 is less than the radius of the center of the dealership 42 and the geo-fence boundary, then the vehicle 12 enters/breaks/crosses the boundary. When the vehicle enters/breaks/crosses the boundary, the processor 54 initiates the transmission of a signal from the telematics unit 26 to the server 38 that the vehicle 12 is in fact within proximity of the dealership 42. The vehicle 12 crossing the geo-fence 82 and the recognition by the server 38 is shown at reference numeral 206 in FIG. 2.

Also shown at reference numeral 206 is the vehicle 12 establishing a short range wireless connection 16 with the WAP at the dealership 42. This may be accomplished using the identification code(s) previously described. Once the short range wireless connection is made, vehicle data may be transferred from the vehicle 12 to the electronic device 40 for use by the dealership employees.

In addition to being configured to recognize when the vehicle 12 has broken, crossed, or entered the geo-fence 82, the server 38 is also configured to receive subscriber vehicle identifying data 84 from the vehicle 12 (see reference numeral 208 in FIG. 2) in the form of packet data. In this example, the communications module 74 receives the packet data from the telematics unit 26, and the packet data may include, for instance, vehicle data representing a then-current location of the subscriber vehicle 12 that is within the geo-fence and the subscriber vehicle identifying data 84. Upon receiving the packet data, the communications module 74 unpacketizes the data, and transmits the data to the server 38. In an example, the transmission sent from the processor 54 to the server 38 may include the vehicle identification number (VIN). The server 38 includes software (to be run by processor 72 or another processor associated with the server 38) that is capable of extracting the VIN from the transmission in order to identify the vehicle 12.

The server 38 also includes software (to be run by processor 72 or another processor associated with the server 38) that enables it to use the extracted VIN to identify the in-vehicle infotainment capabilities of the vehicle 12. As shown at reference numeral 210 in FIG. 2, the server 38 may use the VIN to interrogate the database 68 and/or the database 47 for any records associated with the VIN, and thus the vehicle 12. The vehicle 12 record(s) stored in the database 68 and/or 47 may include the vehicle data history (e.g., service records, maintenance records, etc.), the vehicle specifications, the vehicle capabilities (including infotainment capabilities), and any other vehicle related information. As such, a query of the database 68 and/or 47 with the VIN will indicate to the server 38 the vehicle's infotainment capabilities. In an example, the VIN is used as an index to a table of Production Options associated with the VIN. The table of Production Options contains fields that are associated with particular vehicle capabilities, such as, for example, the infotainment capabilities.

Upon learning the infotainment capabilities of the vehicle 12, the server 38 can make a determination, by running suitable software, as to the type of message 86 to be sent to the vehicle 12. The message 86 may be a text message, an audio message, a video message, or a multimedia message, depending upon the infotainment capabilities of the vehicle 12. By determining the vehicle infotainment capabilities, the server 38 can construct a message that is based on one or more specific technologies.

When the in-vehicle infotainment capabilities of the subscriber vehicle 12 include an ability to play a video, the server 38 may be programmed to generate a message 86 that includes a video to be displayed on the in-vehicle display 62. When the in-vehicle infotainment capabilities of the subscriber vehicle 12 include the ability to play audio messages over the speaker(s) 60, the server 38 may be programmed to generate an audio message. When the in-vehicle infotainment capabilities of the subscriber vehicle 12 include the ability to display text messages on the display 62, the server 38 may be programmed to generate a text message. When the in-vehicle infotainment capabilities of the subscriber vehicle 12 include two or more of the above-listed capabilities, the type of message 86 may be any one of a text, audio or video message, or it may be a multimedia message including a combination of text and audio, text and video, audio and video, or text, audio and video. Multimedia messages may also utilize still pictures/portraits in combination with text, audio and/or video.

The content of the message 86 may depend upon the dealership preferences for the message 86, any advertisers that are associated with the messaging service, the preferences and/or habits of the vehicle owner/driver, or any other parameters relating to customization of the message for the subscriber. The content of the message 86 may be in any of the forms previously described, and will vary, depending upon the infotainment capabilities of the subscriber vehicle 12 that is to receive the message 86.

In determining the content of the message 86, the server 38 may be programmed to identify content that is available for the message based upon the type of message that can be sent to the vehicle 12, and then select or generate a message that includes the available content. In general, the server 38, upon learning the vehicle infotainment capabilities, is programmed to search and select a pre-generated or pre-recorded message that corresponds with the infotainment capabilities, or to dynamically generate a message (either from scratch or using pre-generated or pre-recorded messages in combination with dynamic data e.g., received from the dealership computer systems or from the vehicle 12). Whether the server 38 uses a pre-generated message or a dynamically generated message may depend upon whether the appointment includes dealership notes or instructions about a particular message that is to be used.

As an example, the server 38 first determines the vehicle 12 infotainment capabilities and then checks the service appointment to see if a dealership instruction is present. If an instruction is not present, the server 38 is programmed to select (from pre-generated messages stored in a memory) or dynamically generate any message corresponding with the infotainment capability. Examples of this are discussed below. If an instruction is present, however, the server 38 can construct the message based upon the instruction.

For example, if the user of the vehicle 12 has a preference as to a particular service technician at the dealership (as learned by the dealership 42, e.g., from the user's history with the dealership, survey results, compliment cards, lack of complaints, etc.), the dealership 42 can make a note in the service appointment that service technician A should assist the user. The server 38 recognizes this instruction in the appointment, and can select or generate a message that involves information about the service technician. As an example, the server 38 could extract a picture of service technician A from a memory of the dealership's computing equipment (to which the server 38 has access) and couple it with a pre-recorded audio message that welcomes the user to the dealership and informs the user that service technician A is looking forward to seeing him/her. As another example, the server 38 could extract the picture of service technician A from a memory of the dealership's computing equipment and couple it with a dynamically generated text message (for display within the vehicle 12) that welcomes the user to the dealership and informs the user that service technician A is looking forward to seeing him/her.

For still another example, the dealership 42 may have in its records that the user of the vehicle 12 likes vanilla lattes, and may make a note of the drink preference in the service appointment. The server 38 recognizes this instruction in the appointment, and can select or generate a message that involves information about the drink preference. For example, the server 38 could select a pre-generated video illustrating the drink station, and could dynamically generate a voice over welcoming the user and directing him/her to the drink station to enjoy a vanilla latte.

The dealership 42 may also generate messages that it wants transmitted to the vehicle 12 upon its arrival. These messages are uploaded to the server 38 or are linked to in the appointment. The server 38 is programmed to look for these types of messages prior to selecting other, more generic messages or dynamically generating a message.

When a dealership instruction is not present, the server 38 may be programmed to search dealership data records for the vehicle 12 (which may include customer preferences) and/or to search the subscriber profile in the database 68 to construct the message 86 based upon information within the records and/or profile.

Still further, when an instruction is not present, the server 38 may be programmed to request updated vehicle diagnostic data from the vehicle 12 and then construct the message based on that data. This data may be used to construct, for example, predictive service messages and/or scheduling messages. As one example, if the vehicle data indicates that the vehicle 12 is due for some maintenance or other service, the server 38 can select a message (from a memory) using a heading or domain associated with the maintenance or other service (e.g., tire pressure, oil change, etc.). Under each heading/domain, string templates are available for selection. These string templates are pre-generated audio or text messages that include angle brackets <> where dynamically obtained vehicle data is to be inserted. For example, the message may say “Welcome <name>, your average tire pressure is at <data>, we recommend that you have your tires checked while at the dealership”, and the dynamically obtained vehicle data will be inserted by the server 38 prior to transmission of the message 86 to the vehicle 12. For another example, if the oil life data and fluid level information indicates that an oil change is recommended in the near future and that the windshield washer fluid is low, the message(s) 86 that may be generated could include: “Hello <name>, we see that your windshield washer fluid is low and we will be happy to fill it for you during your visit today”, or “Your vehicle does not need it now, but we recommend an oil change in the near future. Would you like to schedule a visit now?”, or combinations of these two messages.

The server 38 may also be programmed to use dealership data record or subscriber profile information in combination with vehicle data. As an example, upon pulling up the dealership data record for the vehicle 12, the server 38 may recognize that the user/customer prefers to have his or her oil changed every three thousand miles. The server 38 can then request data from the vehicle 12 to determine whether the three thousand mile interval is approaching, is current or has expired. The server 38 can then construct the message 86 to inform the user that the three thousand mile interval is approaching, is current or has expired.

It is to be understood that if the dealership data record, the subscriber profile information, and/or the vehicle data does not provide the server 38 with content for the message, the server 38 may be programmed to select a default welcome message suitable for the vehicle's infotainment capabilities.

Other examples of the message 86 will now be discussed. In an example, the content of the message 86 may be as simple as a dealership welcome message. This type of message may be personalized with the vehicle owner's name, which the server 38 extracts from the vehicle record(s) associated with the VIN. This type of message can also inform the user where to park, the employee he is scheduled to work with while at the dealership 42, the service to be performed, or any other dealership 42 related information. For example, a welcome message 86 may include a greeting, instructions for parking, and information about where the user should go once inside the dealership 42 (e.g., a text or audio message stating, “welcome to Dealership X, please park in the reserved customer only parking to the right, and then come to the service desk where Joe will be waiting to assist you”). As another example, the welcome message 86 may be a high-definition video (or other lower definition video) with a greeting from the dealership owner along with a brief history of the dealership 42.

In another example, the content of the message 86 may include an advertisement, alone or in combination with a coupon, from the dealership 42, the telematics service provider, or some other entity that purchases an advertisement through the telematics service provider. As an example, the content of the message 86 may include a welcome greeting from the dealership 42 and a coupon for an oil change at the dealership 42. It is to be understood that any offer from the dealership 42 may be a preset offer or may be dynamically determined based upon the vehicle data that is retrieved by the server 38. For example, if the vehicle data indicates that the vehicle 12 is due for some service (oil change, tire rotation, etc.), the server 38 may be programmed to offer a discount for that particular service on that particular day, within that particular week, etc. As another example, the content of the message 86 may include a welcome greeting and a coupon for the coffee shop that is located next to the dealership 42. Any coupon that is presented in the message 86 may be associated with a time limit (e.g., today only, etc.). In an example, a video message may include an offer from a telematics service provider detailing new services that are being offered for a limited time. As will be discussed hereinbelow, the content of the video message may depend, at least in part, on driver related information.

In still another example, the content of the message 86 may include information that is specifically tailored to the vehicle 12 or the vehicle owner/user (as previously mentioned). The server 38 may include software that, when run, retrieves a subscriber profile from the database 68 in response to the receipt of the VIN, retrieves a dealership data record from the dealership computing equipment, and/or request data from the vehicle 12. The subscriber profile may include vehicle owner/driver personal information as well as driving habits of the owner/driver or other heuristic data that has previously been stored. The server 38 may use the personal information within the subscriber profile to further tailor the content of the message 86 to the vehicle owner/driver. For example, if the stored driving habits indicate that the vehicle user stops at a coffee shop four days a week, the text, audio, and/or video message 86 may welcome the user and invite him/her inside the dealership 42 for a cup of coffee. Examples of how the dealership data record(s) and/or vehicle data may be used in the message 86 were previously described.

The preferences of the vehicle user/owner may be received by a variety of mechanisms. For example, user feedback may be obtained through a survey (e.g., taken at the dealership, over the phone, via a web page), interactively via voice and a telematics service within a vehicle, through a smartphone app, etc. Any preferences that are obtained may be input into the data records and/or profile for subsequent retrieval and use.

It is to be understood that the content of the message 86 may also include any combinations of welcome and dealership-related content, advertisement(s), and/or vehicle 12 and/or vehicle owner/user tailored content. For example, the message 86 may welcome the vehicle owner, may inform the user of the dealership's special on oil changes, and may also include a coupon for a retailer down the street from the dealership or recognized as being a place frequented by the vehicle owner/driver.

As shown at reference numeral 212 in FIG. 2, the server 38 is also capable of transmitting the message 86 to the vehicle 12 (e.g., using the communications module 74 and the communication system 14). In an example, the communications module 74 includes suitable communications equipment, such as switches, switchboards, etc., modems, TCP/IP supporting equipment, and/or the like, to enable the server 38 to establish a communication with, for example, the telematics unit 26, or vice versa. The communications module 74 is also configured to enable the call center 30 to establish a communication with the dealership 42.

While not shown in FIG. 2, it is to be understood that some examples of the method may involve the vehicle owner/driver setting preferences for the message(s) 86 and/or the servicing of the vehicle 12. For example, when a vehicle owner/driver signs up for the telematics service provider services (over the phone or using the Internet), he/she may be able to indicate specific message type and/or content. For example, a vehicle owner/user may set preferences for receiving video messages only, for including coupons whenever they are available, for limiting content to dealership messages alone, etc. The vehicle/user preferences may be stored in the subscriber profile in the database 86, and thus may be accessed by the server 38 prior to generating the message 86.

The server 38 disclosed herein may utilize the processor 72 to run any of the software/computer readable code disclosed herein. In general, the processor 72, which is often used in conjunction with the computer equipment 76, is generally equipped with suitable software and/or programs enabling the processor 72 (and server 38) to accomplish a variety of call center functions. Further, the various operations of the call center 30 may be carried out by one or more computers (e.g., computer equipment 76) programmed to carry out some of the tasks of the call center 30. The computer equipment 76 (including computers) may include a network of servers (including server 38) coupled to both locally stored and remote databases (e.g., database 68, 47) of any information processed.

Referring back to FIG. 1, the call center 30 also includes the switch 36, which may be a private branch exchange (PBX) switch. The switch routes incoming signals so that voice transmissions are usually sent to either the live advisor 70 or the automated response system 70′, and data transmissions are passed on to a modem or other piece of equipment (not shown) for demodulation and further signal processing. The modem preferably includes an encoder, as previously explained, and can be connected to various devices such as the server 36 and database 68.

As mentioned above, the database(s) 68 may be designed to store vehicle record(s), subscriber profile records, subscriber behavioral patterns, or any other pertinent subscriber and/or vehicle information. In an example, the database(s) 68 may be configured to store the user profile mentioned above, which may contain personal information of the subscriber (e.g., the subscriber's name, garage address, billing address, home phone number, cellular phone number, etc.), as well as subscriber selected messaging related preferences. It is to be understood that the databases 68 may allow the call center 30 to function as a repository for data collected from the vehicle 12 and/or from the vehicle owner/driver. In some instances, another facility may function as a repository for collected data (e.g., a lab (not shown) associated with the call center 30 whose database(s) the server 38 can access).

It is to be appreciated that the call center 30 may be any central or remote facility, manned or unmanned, mobile or fixed, to or from which it is desirable to exchange voice and data communications. As such, the live advisor 70′ may be physically present at the call center 30 or may be located remote from the data center 100 while communicating therethrough.

The call center 30 shown in FIG. 1 may also be virtualized and configured in a Cloud Computer, that is, in an Internet-based computing environment. For example, the computer equipment 76 may be accessed as a Cloud platform service, or PaaS (Platform as a Service), utilizing Cloud infrastructure rather than hosting computer equipment 76 at the call center 30. The database 68 and server 38 may also be virtualized as a Cloud resource. The Cloud infrastructure, known as IaaS (Infrastructure as a Service), typically utilizes a platform virtualization environment as a service, which may include components such as the processor 72, database 68, server 38, and computer equipment 76. In an example, the messaging software and services disclosed herein may be performed in the Cloud via the SaaS (Software as a Service). Subscribers, in this fashion, may access any related software applications (e.g., user-setting pages) remotely via the Cloud. Further, subscriber service requests may be acted upon by the automated advisor 70, which may be configured as a service present in the Cloud.

While not shown, the system 10 shown in FIG. 1 also includes a communications network provider, which generally owns and/or operates the carrier/communication system 14. The communications network provider includes a mobile network operator that monitors and maintains the operation of the communications network. The network operator directs and routes calls, and troubleshoots hardware (cables, routers, network switches, hubs, network adaptors), software, and transmission problems. It is to be understood that, although the communications network provider may have back-end equipment, employees, etc. located at the call center 30, the call center 30 is a separate and distinct entity from the network provider. In another example, the equipment, employees, etc. of the communications network provider are located remote from the call center 30. The communications network provider provides the user with telephone and/or Internet services, while the call center 30 provides a variety of telematics-related services (such as, for example, those discussed hereinabove). The communications network provider may interact with the call center 30 to provide services (such as emergency services) to the user.

Reference throughout the specification to “one example”, “another example”, “an example”, and so forth, means that a particular element (e.g., feature, structure, and/or characteristic) described in connection with the example is included in at least one example described herein, and may or may not be present in other examples. In addition, it is to be understood that the described elements for any example may be combined in any suitable manner in the various examples unless the context clearly dictates otherwise.

In describing and claiming the examples disclosed herein, the singular forms “a”, “an”, and “the” include plural referents unless the context clearly dictates otherwise.

While several examples have been described in detail, it will be apparent to those skilled in the art that the disclosed examples may be modified. Therefore, the foregoing description is to be considered non-limiting.

1. A method for servicing a subscriber vehicle, comprising:
receiving, at a server, a notification that the subscriber vehicle has an appointment with a dealership;
setting up a geo-fence around the dealership;
recognizing, at the server, that the subscriber vehicle has entered the geo-fence;
receiving, at the server, subscriber vehicle identifying data;
identifying, at the server, in-vehicle infotainment capabilities of the subscriber vehicle by interrogating a database in connection with the server; and
transmitting, from the server, a message to the subscriber vehicle that is tailored to the in-vehicle infotainment capabilities.

2. The method as defined in claim 1 wherein the in-vehicle infotainment capabilities of the subscriber vehicle include an ability to play a video, and wherein the message is a welcome message with a video displayed on an in-vehicle display.

3. The method as defined in claim 1 wherein the in-vehicle infotainment capabilities of the subscriber vehicle include audio capabilities, text capabilities, or combinations thereof, and wherein the message is an audio welcome message, a text welcome message, or a combination of an audio and text welcome message.

4. The method as defined in claim 1, further comprising:
in response to the receipt of the subscriber vehicle identifying data, reviewing, by the server, a subscriber profile for driver related information; and
further tailoring the message based upon the driver related information.

5. The method as defined in claim 4 wherein the message includes a retailer coupon based on the driver related information.

6. The method as defined in claim 1, further comprising:
establishing a connection between the vehicle and a short-range wireless communication network of the dealership; and
transmitting vehicle data to an electronic device of the dealership over the connection.

7. The method as defined in claim 6 wherein a telematics unit of the subscriber vehicle includes an identification code associated with a wireless access point at the dealership, the identification code being previously approved so that the telematics unit is capable of establishing the connection with dealership through the wireless access point.

8. The method as defined in claim 6, further comprising transmitting a dealership related coupon to the subscriber vehicle from the electronic device, the dealership related coupon being based upon the vehicle data received.

9. The method as defined in claim 1 wherein prior to servicing the subscriber vehicle, the method further comprises designating, in a subscriber profile stored in a database at the telematics service center, preferences pertaining to the servicing of the subscriber vehicle, the designating being accomplished through any of a remotely accessible page, a voice connection with the telematics service center, or an electronic mailing message.

10. A system for providing services to a subscriber vehicle, comprising:
a server; and
computer readable instructions embodied on a non-transitory, tangible computer readable medium, the computer readable instructions executable by a processor of the server and including:
computer readable instructions for receiving a notification that the subscriber vehicle has an appointment with a dealership;
computer readable instructions for recognizing that the subscriber vehicle has entered a geo-fence set up around the dealership in response to receiving the notification;
computer readable instructions for receiving subscriber vehicle identifying data;
computer readable instructions for identifying in-vehicle infotainment capabilities of the subscriber vehicle by interrogating a database in connection with the server; and
computer readable instructions for transmitting a message to the subscriber vehicle that is tailored to the in-vehicle infotainment capabilities.

11. The system as defined in claim 10 wherein the in-vehicle infotainment capabilities of the subscriber vehicle include an ability to play a video, and wherein the message is a welcome message with a video to be displayed on an in-vehicle display.

12. The system as defined in claim 10 wherein the in-vehicle infotainment capabilities of the subscriber vehicle include audio capabilities, text capabilities, or combinations thereof, and wherein the message is an audio welcome message, a text welcome message, or a combination of an audio and text welcome message.

13. The system as defined in claim 10, further comprising a subscriber profile, accessible by the server, including driver related information, and wherein the message is based upon the driver related information.

14. The system as defined in claim 13 wherein the message includes a retailer coupon based on the driver related information.

15. The system as defined in claim 10, further comprising an electronic device of the dealership to receive vehicle data over a connection between the vehicle and a short-range wireless communication network of the dealership.

16. The method as defined in claim 15, further comprising a telematics unit of the subscriber vehicle including an identification code associated with a wireless access point at the dealership, the identification code being previously approved so that the telematics unit is capable of establishing the connection with dealership through the wireless access point.
